(19) United States
(12) Patent Application Publication
(10) Pub. No.: US 2010/0065672 A1
(43) Pub. Date: Mar. 18, 2010

(54) RECORDING TAPE CARTRIDGE

(75) Inventor: Hideaki SHIGA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/549,398

(22) Filed: Aug. 28, 2009

(30) Foreign Application Priority Data
Sep. 18, 2008 (JP) 2008-239253

(51) Int. Cl. G11B 23/107

(52) U.S. Cl. 242/348.2

(57) ABSTRACT

A recording tape cartridge includes a case, a shielding member, a first dustproofing wall portion and a second dustproofing wall portion. The case rotatably accommodates a single reel on which a recording tape is wound. An aperture is formed in a side wall of the case for drawing out of a leader member attached to an end portion of the recording tape. The shielding member slides along the side wall to open and close the aperture. The first dustproofing wall portion is provided protruding from a portion of the side wall, and the second dustproofing wall portion is provided protruding from the shielding member. When the aperture is closed, the first dustproofing wall portion opposes the shielding member and the second dustproofing wall portion contacts or is proximate to the first dustproofing wall portion.

### CROSS-REFERENCE TO RELATED APPLICATION

This application claims priority under 35 USC 119 from Japanese Patent Application No. 2008-239253 filed on Sep. 18, 2008, the disclosure of which is incorporated by reference herein.

### BACKGROUND OF THE INVENTION

1. Technical Field

The present invention relates to a recording tape cartridge which accommodates a single reel within a case, a recording tape such as a magnetic tape or the like, which is principally employed as a recording/reproducing medium of a computer or the like, being wound on the reel.

2. Related Art

Heretofore, a recording tape cartridge has been known in which a recording tape such as a magnetic tape or the like is wound on a reel and the single reel is rotatably accommodated in a case, and the recording tape cartridge is employed as a data recording/reproducing medium of a computer or the like. At a distal end of this recording tape, a leader member, such as a leader pin, a leader tape, a leader block or the like is provided. Drawing-out means, which is provided at a drive device, draws the leader member out through an aperture of the recording tape cartridge and winds the recording tape onto a take-up reel at the drive device.

In a recording tape cartridge with such a structure, a position of the aperture and a type of a door (a shielding member) that opens and closes the aperture are different for each type of leader member. In a case in which the leader member is a leader pin, for example, as illustrated in Japanese Patent Application Laid-Open (JP-A) No. 2004-30760, the aperture is formed at a corner portion of a side wall which is formed at a side of loading into a drive device, and the aperture is opened and closed by a door that slides in a direction parallel to the direction of loading into the drive device, or a door with a circular arc form in plan view that slides along a predetermined circumference, or the like.

### SUMMARY

In a case of a structure in which the aperture is opened and closed by a shielding member that slides, groove portions are formed in a ceiling plate inner face and a floor plate inner face of the case. Top and bottom portions of the shielding member fit into the groove portions, and the sliding direction and sliding operations thereof are defined by the groove portions. Thus, a “labyrinth construction” is formed by the groove portions and the shielding member overlapping at these portions, and ingression of dust and the like is suppressed.

However, in order to allow the shielding member to slide smoothly, and in accordance with a draft angle of a mold or a deformation such as warping or the like at the time of molding of the recording tape cartridge, a gap of a certain extent is formed between the shielding member and the side wall in which the aperture is formed. Consequently, at times of non-use of the recording tape cartridge (when not loaded in the drive device, during storage and during transport and the like), dust or the like may ingress through this gap.

Accordingly, the present invention will provide a recording tape cartridge capable of suppressing ingression of dust and the like through a gap that is formed between a shielding member that slides and a side wall in which an aperture is formed, and capable of improving dustproofing.

A recording tape cartridge of a first aspect of the present invention includes a case that rotatably accommodates a single reel on which recording tape is wound; a shielding member that slides along a side wall of the case, and opens and closes an aperture which is formed in the side wall for drawing out of a leader member attached to an end portion of the recording tape; a first dustproofing wall portion that is provided protruding from a portion of the side wall; and a second dustproofing wall portion that is provided protruding from the shielding member, wherein, when the aperture is closed, the first dustproofing wall portion opposes the shielding member and the second dustproofing wall portion contacts or is proximate to the first dustproofing wall portion.

According to the recording tape cartridge of the first aspect, the first dustproofing wall portion, which is provided protruding from the side wall in which the aperture is formed, and the second dustproofing wall portion, which protrudes from the shielding member, contact or are proximate when the shielding member has slid to close the aperture. Therefore, ingression of dust and the like through a gap formed between the shielding member and the side wall may be suppressed, and dustproofing of the recording tape cartridge may be improved.

A recording tape cartridge of a second aspect of the present invention is the recording tape cartridge of the first aspect, in which the first dustproofing wall portion and the second dustproofing wall portion include lengths of at least a height of the aperture.

According to the recording tape cartridge of the second aspect, the first dustproofing wall portion and the second dustproofing wall portion have lengths of at least the height of the aperture. Thus, ingression of dust and the like through the gap formed between the shielding member and the side wall may be suppressed, and the dustproofing of the recording tape cartridge may be further improved.

A recording tape cartridge of a third aspect of the present invention is the recording tape cartridge of the first aspect or second aspect, in which the first dustproofing wall portion and the second dustproofing wall portion contact or are proximate so as to overlap with one another in a direction of thickness of the shielding member.

According to the recording tape cartridge of the third aspect, the first dustproofing wall portion and the second dustproofing wall portion overlap with one another in the thickness direction of the shielding member, and thus a blocking structure (a labyrinth construction) may be formed by the first dustproofing wall portion and the second dustproofing wall portion. Consequently, ingression of dust and the like through the gap formed between the shielding member and the side wall may be suppressed, and the dustproofing of the recording tape cartridge may be further improved.

A recording tape cartridge of a fourth aspect of the present invention is the recording tape cartridge of the third aspect, in which surfaces of the first dustproofing wall portion and the second dustproofing wall portion that contact or are proximate one another are formed so as to be provided in a direction substantially orthogonal to a direction of sliding of the shielding member

According to the recording tape cartridge of the fourth aspect, the surfaces of the first dustproofing wall portion and the second dustproofing wall portion that oppose one another are formed so as to be provided along the direction substantially orthogonal to the sliding direction of the shielding member. Thus, an excellent blocking structure (labyrinth construction) may be formed by the first dustproofing wall portion and the second dustproofing wall portion. Consequently, ingression of dust and the like through the gap formed between the shielding member and the side wall may be suppressed, and the dustproofing of the recording tape cartridge may be further improved.

A recording tape cartridge of a fifth aspect of the present invention is a recording tape cartridge of the first to fourth aspects, in which the first dustproofing wall portion is provided protruding from an edge portion, of the side wall, that forms the aperture.

According to the recording tape cartridge of the fifth aspect, because the first dustproofing wall portion is provided protruding from an edge portion of the side wall forming the aperture, ingression of dust and the like through the gap formed between the shielding member and the side wall may be suppressed in the vicinity of an entrance to the gap, and further prevented.

As described above, according to the recording tape cartridge of each aspect of the present invention, a recording tape cartridge can be provided that may suppress ingression of dust and the like through the gap formed between the shielding member and the side wall in which the aperture is formed and that may improve dustproofing.

### BRIEF DESCRIPTION OF THE DRAWINGS

Embodiments of the present invention will be described in detail based on the following figures, wherein:

FIG. 1 is a schematic perspective view of a recording tape cartridge;

FIG. 2 is a schematic exploded perspective view of the recording tape cartridge, when viewed from above;

FIG. 3 is a schematic exploded perspective view of the recording tape cartridge, when viewed from below;

FIG. 4 is a schematic perspective view illustrating a state when a shielding member of a first exemplary embodiment has closed an aperture and the shielding member has opened the aperture;

FIG. 5 is a schematic plan view illustrating the state when the shielding member of the first exemplary embodiment has closed the aperture;

FIG. 6 is a schematic plan view illustrating a state when a shielding member of a variant example of the first exemplary embodiment has closed the aperture; and

FIG. 7 is a schematic plan view illustrating a state when a shielding member of a second exemplary embodiment has closed an aperture.

### DETAILED DESCRIPTION OF THE INVENTION

Herebelow, the exemplary embodiment of the present invention will be described in detail on the basis of the example illustrated in the drawings. Herein, for convenience of explanation, a loading direction of a recording tape cartridge 10 into a drive device is shown as arrow A, and is a forward direction (front side) of the recording tape cartridge 10. The direction of an arrow B that is orthogonal to arrow A is a rightward direction (right side). Further, a direction that is orthogonal to the direction of arrow A and the direction of arrow B is shown as arrow C, and is an upward direction (upper side) of the recording tape cartridge 10.

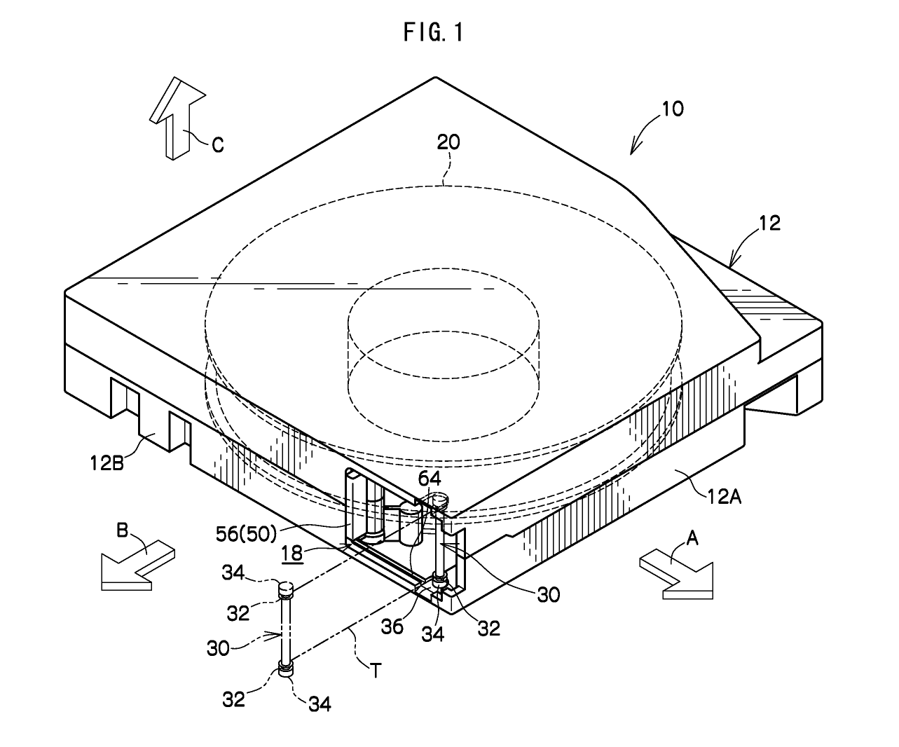

Firstly, a first exemplary embodiment will be described. As shown in FIG. 1 to FIG. 3, the recording tape cartridge 10 includes a substantially rectangular box-form case 12. An upper case 14 and a lower case 16 are made of a resin such as polycarbonate (PC) or the like. A peripheral wall 14B stands erect from the peripheral edge of a ceiling plate 14A, and a peripheral wall 16B stands erect from the peripheral edge of a floor plate 16A. In a state in which the peripheral wall 14B and the peripheral wall 16B are abutted together, the upper case 14 and the lower case 16 are joined by ultrasonic welding, screw-fixing or the like, and thus the case 12 is structured.

That is, screw bosses 15 are formed at, for example, respective corner portion vicinities of each of the upper case 14 and the lower case 16, and unillustrated screws are threadingly engaged with these screw bosses 15 from the lower face side of the lower case 16. Thus, the case 12 is assembled. A single reel 20 is rotatably accommodated inside the case 12.

A reel hub 22 in the shape of a circular tube with a base constitutes a central portion of the reel 20, and a lower flange 26 provided at a lower end portion of the reel hub 22 is formed integrally with the reel hub 22. An upper flange 24 is ultrasonically welded to an upper end portion of the reel hub 22, and thus the reel 20 is structured. A recording tape T such as a magnetic tape or the like, which serves as an information recording/reproducing medium, is wound on an outer peripheral surface of the reel hub 22. Width direction end portions of the wound-on recording tape T are retained by the upper flange 24 and the lower flange 26.

A reel gear 44 is formed in an annular shape at a lower face of a base wall 28 of the reel hub 22. A gear aperture 40 for exposing the reel gear 44 to the exterior is formed in a central portion of the lower case 16. The reel gear 44 that is exposed through the gear aperture 40 is meshed with a driving gear (not shown) that is formed at a rotary shaft (not shown) of a drive device. By rotary driving of the driving gear, the reel 20 in the case 12 may be relatively rotated with respect to the case 12.

A reel plate 46, which is a circular metal plate formed of a magnetic material, is coaxially and integrally fixed at a radial direction inner side of the reel gear 44 at the lower face of the base wall 28 by insert-molding. The reel plate 46 is configured to be attracted and retained by magnetic force of an annular magnet (not shown) that is provided at the rotary shaft of the drive device. The reel 20 is retained so as not to rattle by free play-restricting walls 42, which are partially provided protruding from respective inner faces of the upper case 14 and the lower case 16 and which serve as inner walls on circular paths that are concentric with the gear aperture 40.

An aperture 18 for drawing out of the recording tape T that is wound on the reel 20 is formed in a right side wall 12B of the case 12. A leader pin 30, which is operated by being drawn out while caught on (engaged) by a drawing-out member (not shown) of the drive device, is fixed to a free end of the recording tape T that is to be drawn out through the aperture 18. At each of two end portions of the leader pin 30, which protrude beyond width direction end portions of the magnetic tape T, an annular groove 32 is formed. These annular grooves 32 are caught on by hooks or the like of the drawing-out member. Thus, with this structure, the hooks or the like do not touch and damage the magnetic tape T when the magnetic tape T is being drawn out.

At an inner side of the aperture 18 of the case 12, a pair of upper and lower pin retention portions 36 are provided in the ceiling plate 14A of the upper case 14 and the floor plate 16A of the lower case 16, for positioning and retaining the leader pin 30 in the case 12. The pin retention portions 36 have semi-tubular forms, which are open to the recording tape T drawing out side thereof. Two end portions 34 of the leader pin 30 in a standing state are configured to be capable of exit/entry into the pin retention portions 36 from the open side thereof.

A leaf spring 38 is fixedly disposed in a vicinity of the pin retention portions 36. Bifurcate distal end portions of the leaf spring 38 engage with the upper and lower end portions 34, respectively, of the leader pin 30, and retain the leader pin 30 in the pin retention portions 36. The distal end portions of the leaf spring 38 are constituted to resiliently deform appropriately when the leader pin 30 is being removed or inserted at the pin retention portions 36, and allow movements of the leader pin 30.

The aperture 18 is opened and closed by a door 50 as a shielding member. The door 50 is formed in a substantially rectangular plate form with a size capable of closing off the aperture 18. Groove portions 64, into which upper and lower end portions of the door 50 are slidably fitted, are formed in the ceiling plate 14A and the floor plate 16A at the inner side of the aperture 18, such that the door 50 may move (slide) at the inner side of the right side wall 12B and along the right side wall 12B of the case 12.

A shaft 52 protrudes from the middle of a rear end portion of the door 50. A coil spring 58 is fitted round the shaft 52. A broadened portion 54 is formed at a rear end of the shaft 52 in order to prevent the coil spring 58 falling off. A support block 60 is provided protruding from the lower case 16. The support block 60 includes an anchoring portion 62 that anchors a rear end of the coil spring 58 fitted onto the shaft 52.

Therefore, because the shaft 52 is slidably supported on the support block 60 and the rear end of the coil spring 58 is anchored at the anchoring portion 62, the door 50 is a structure which is urged in the direction of closing the aperture 18 by urging force of the coil spring 58. It is preferable if a support block 66, which supports the shaft 52 at a time of opening of the aperture 18, is also provided protruding at the rearward side of the support block 60.

A projection 56 for opening and closing operations is provided protruding in a case outward direction from a front end portion of the door 50. In accordance with loading of the recording tape cartridge 10 into a drive device, the projection 56 engages with an opening/closing member (not shown) of the drive device. Accordingly, with this structure, the door 50 opens up in opposition to the urging force of the coil spring 58.

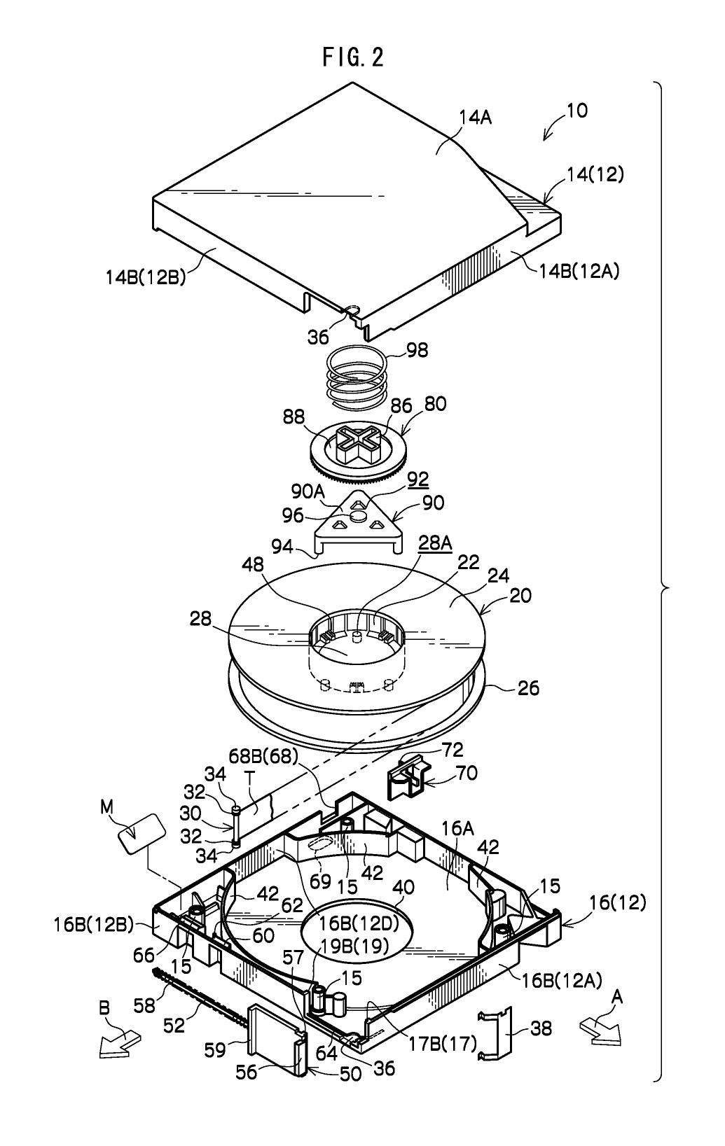

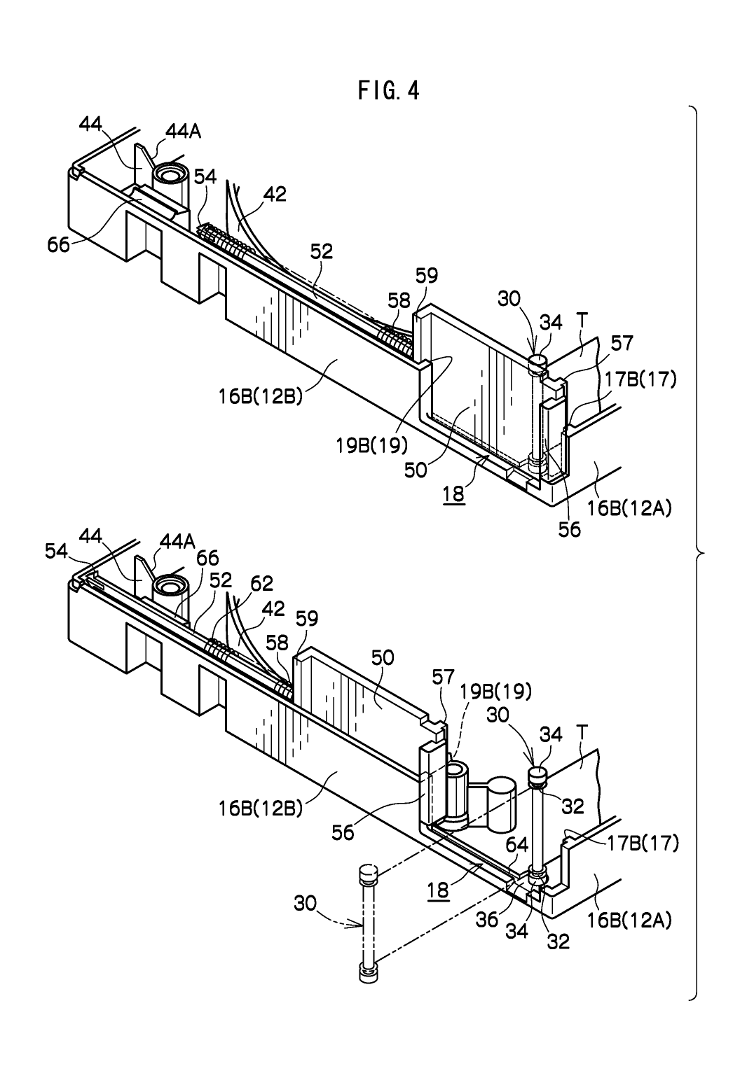

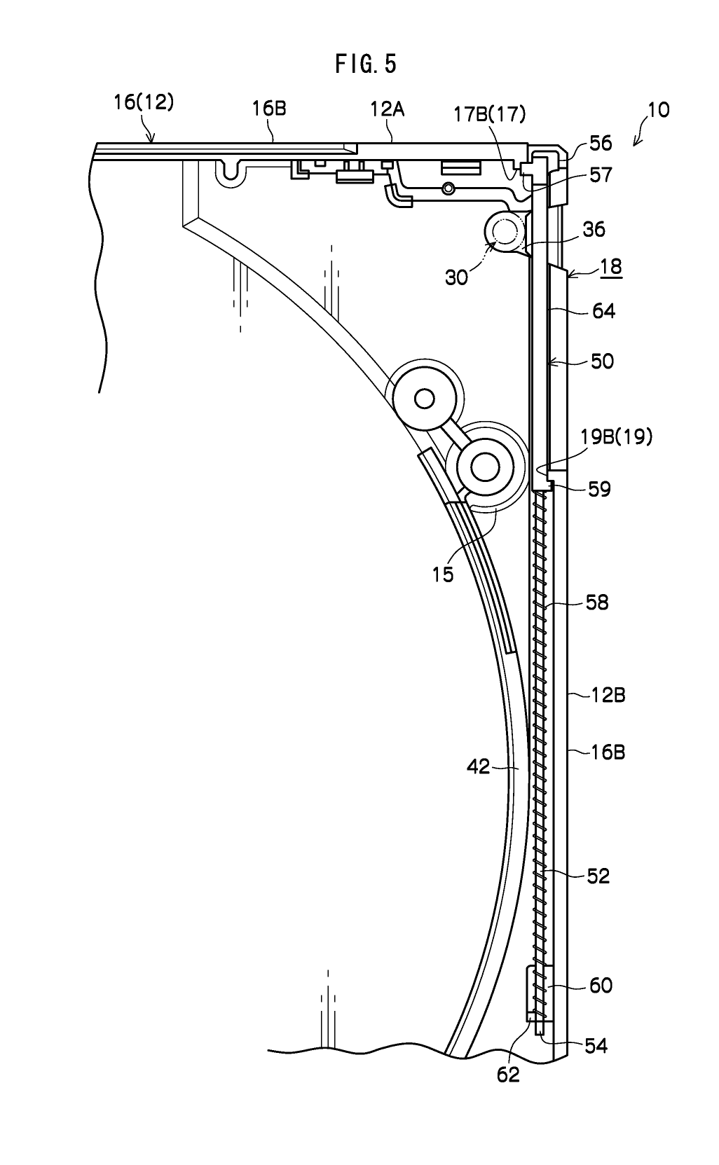

As shown in FIG. 2 to FIG. 5, a projection 59 as a second dustproofing wall portion is formed protruding from the outer face of a portion of a rear end portion of the door 50. The projection 59 has a predetermined width to a case outward direction, and is formed as a single body spanning the whole of the height direction of the door 50 (i.e., has a length of at least the height of the aperture 18). A projection 19 as a first dustproofing wall portion is formed protruding from the right side wall 12B of the case 12. When the aperture 18 is closed off by the door 50, the projection 59 (the second dustproofing wall portion) opposes the inner face of the right side wall 12B of the case 12 and engages with the projection 19 (the first dustproofing wall portion).

That is, projections 19A and 19B are formed integrally at the upper case 14 and the lower case 16, respectively. The projections 19A and 19B protrude with a predetermined height to a case inward direction from the respective inner faces of edge portions of the right side walls 12B of the upper case 14 and the lower case 16. The edge portions of the right side walls 12B form the aperture 18 (the edge portion of the aperture at the side of the direction of sliding when the door 50 opens up the aperture). When the upper case 14 and the lower case 16 have been joined together, the projection 19 configured by the projections 19A and 19B is continuous in the case height direction, and the projection 19 is formed with a length of at least the height of the aperture 18.

When the aperture 18 is closed off by the door 50, the projection 59 of the door 50 engages with the projection 19 from the case rear side over the whole of the height direction of the door 50, that is, the projection 59 and the projection 19 contact or are proximate so as to overlap with one another in a plate thickness direction of the door 50 in plan view. Therefore, when the aperture 18 is closed off by the door 50, a closed structure (a “labyrinth construction”) is formed by the projections 19 and 59, between the inner face of the edge portion of the right side wall 12B that forms the aperture 18 and the outer face of the rear end portion of the door 50. Hence, ingression of dust or the like is suppressed and further prevented.

Similarly, a projection 57, which protrudes to a predetermined height to the case inward direction, is formed as a single body spanning the whole of the height direction of the door 50 (i.e., having a length of at least the height of the aperture 18) at the inner face of a front end portion of the door 50. A projection 17, which protrudes to a predetermined height to the inward direction of the case, is formed as a single body spanning the whole of the height direction of the case 12 (i.e., having a length of at least the height of the aperture 18) at the inner face of an edge portion vicinity of a front side wall 12A.

That is, projections 17A and 17B are formed integrally at the upper case 14 and the lower case 16, respectively. The projections 17A and 17B protrude with a predetermined length to a case inward direction from the respective inner faces of edge portions of the front side walls 12A of the upper case 14 and the lower case 16. The edge portions of the front side walls 12A form the aperture 18. When the upper case 14 and the lower case 16 have been joined together, the projection 17 configured by the projections 17A and 17B is continuous in the case height direction, and the projection 17 is formed with a length of at least the height of the aperture 18.

When the aperture 18 is closed off by the door 50, the projection 57 contacts or is proximate to thereby engaging with the projection 17 over the whole of the height direction of the door 50. Therefore, when the aperture 18 is closed off by the door 50, a closed structure (a “labyrinth construction”) is formed by the projections 17 and 57, between the vicinity of the edge portion of the front side wall 12A that forms the aperture 18 and the front end portion of the door 50. Hence, ingression of dust or the like is suppressed and further prevented.

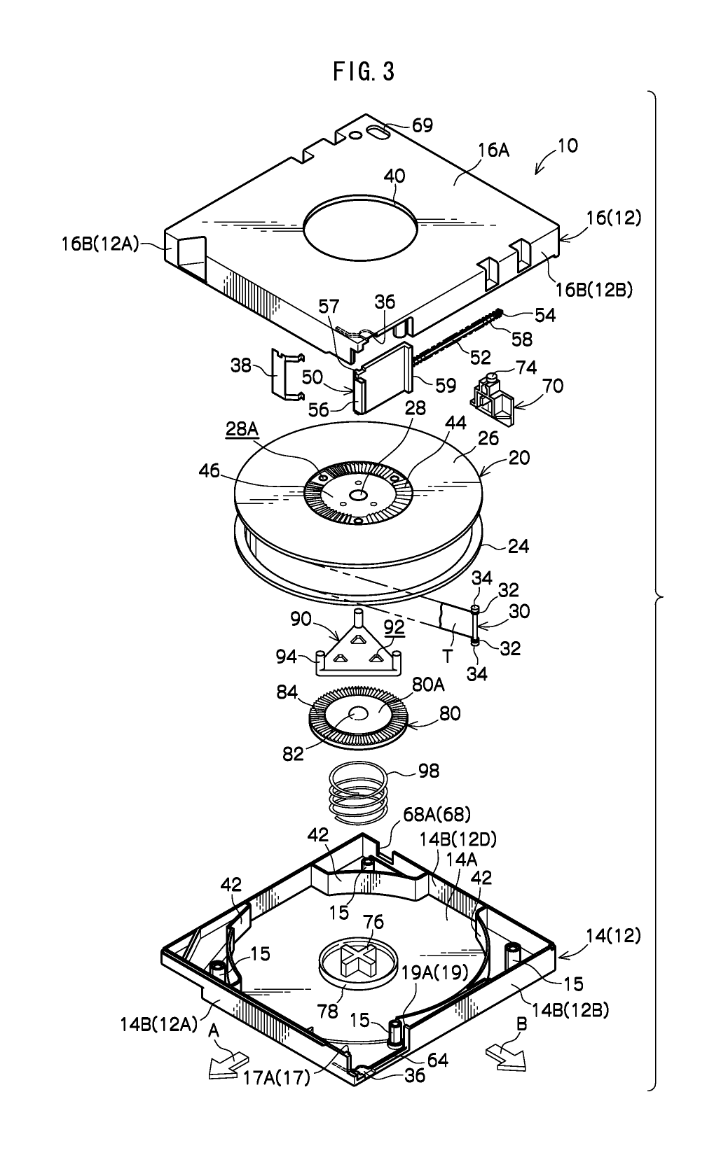

As shown in FIG. 2 and FIG. 3, a write protector 70 is provided at a rear-left portion of the case 12. The write protector 70 specifies whether recording onto the recording tape T is enabled or disabled, and is provided to be slidable in the left-right direction. An aperture hole 68 is formed in a rear side wall 12D of the case 12. An operation protrusion 72, for operation of the write protector 70 by hand, protrudes through the aperture hole 68. When the upper case 14 and the lower case 16 have been joined together, the aperture hole 68 is formed by a cutaway portion 68A formed in the peripheral wall 14B of the upper case 14 and a cutaway portion 68B formed in the peripheral wall 16B of the lower case 16.

Further, a long hole 69 is formed along the left-right direction in the lower case 16. A protrusion 74 of the write protector 70 is exposed through the long hole 69. When the recording tape cartridge 10 is loaded into the drive device, a position of the write protector 70 is sensed at the drive device, and it is automatically judged whether recording to the recording tape T is enabled or disabled. Herein, this protrusion 74 does not protrude beyond the lower face of the lower case 16. Further yet, as shown in FIG. 2, a memory board M is disposed with a predetermined diagonal inclination at the rear-right portion of the case 12. The memory board M stores various kinds of information such as recording capacity, recording format and the like.

As is also shown in FIG. 2 and FIG. 3, engaging gears 48 are plurally (for example, three, at 120° intervals) provided standing from an upper face peripheral edge of the base wall 28 of the reel hub 22, spaced apart equidistantly by predetermined intervals. Between the engaging gears 48, pass-through holes 28A are plurally formed at predetermined positions (in this case, three at 120° intervals) of the reel gear 44. A disk-shaped braking member 80 formed of a resin material is inserted into the interior of this reel hub 22.

A braking gear 84, which is meshable with the engaging gears 48, is formed in an annular shape at a peripheral edge of a lower face 80A of the braking member 80. A rotation-restricting rib 76, in a substantial cross shape in plan view, is provided protruding downward from the inner face of the ceiling plate 14A of the upper case 14. An engaging protrusion 86, in a substantial cross shape in plan view, stands erect from an upper face of the braking member 80 The engaging protrusion 86 is formed to be slightly higher than a height of the rotation-restricting rib 76. The engaging protrusion 86 is inserted inside the rotation-restricting rib 76. Therefore, the braking member 80 may be made non-rotatable with respect to the case 12 (the upper case 14) but movable in the vertical direction, within the reel hub 22.

A compression coil spring 98 is disposed between the upper case 14 and the braking member 80. That is, the compression coil spring 98 is disposed in a state in which one end thereof abuts at an inner side of an annular protrusion 78 that is provided protruding at an outer side of the rotation-restricting rib 76 of the upper case 14 (i.e., the compression coil spring 98 abuts between the rotation-restricting rib 76 and the annular protrusion 78), and the other end abuts inside an annular groove 88 formed in the upper face of the braking member 80. The braking member 80 is continuously urged downward by the urging force of this compression coil spring 98.

Therefore, at times of non-use (when not loaded in a drive device) the recording tape cartridge 10 is in a state in which the braking gear 84 meshes with the engaging gears 48, and is in a rotation-locked state in which relative rotation of the reel 20 with respect to the case 12 is blocked. At such a time, the reel 20 is pushed against the lower case 16 by the urging force, and the reel gear 44 is exposed through the gear aperture 40.

A release member 90, with a substantially equilateral triangle shape in plan view, is formed of a resin material. The release member 90 is inserted inside the reel hub 22, below the braking member 80 (i.e., between the base wall 28 and the braking member 80). Pass-through holes 92, which are formed in predetermined shapes at suitable positions, are plurally formed in the release member 90 (three hexagonal shapes in the illustrated case), enabling a reduction in weight of the release member 90. Leg portions 94 are provided protruding from the lower face of the release member 90 at corner areas thereof. The leg portions 94 are inserted into the pass-through holes 28A and protrude from the lower face of the base wall 28 to a predetermined height beyond the reel gear 44.

A support projection 96 is formed with a flat shape at the middle of an upper face 90A of the release member 90. The support projection 96 abuts against a substantially hemispherical release protrusion 82, which is provided protruding from the middle of the lower face 80A of the braking member 80 (see FIG. 2 and FIG. 3). Thus, an area of contact between the braking member 80 and the release member 90 is reduced and sliding resistance during rotation of the reel 20 is alleviated at times of use. Herein, for example, polyacetal (POM) is used as the material of the braking member 80 and, for example, polybutylene terephthalate (PBT) is used as the material of the release member 90.

Next, operations of the recording tape cartridge 10 with the structure described above will be described. At times of non-use (times of storage, times of transport and the like), the aperture 18 of the recording tape cartridge 10 is closed off by the door 50. Further, the braking member 80 is disposed at the rotation-locked position by the urging force of the compression coil spring 98 and the braking gear 84 is meshed with the engaging gears 48. Therefore, the reel 20 is prevented from rotating relative to the case 12.

At such a time, the projection 59 of the door 50 engages, from the case rearward side, with the projection 19 that is formed with a length of at least the height of the aperture 18 at the inner face of the edge portion of the right side wall 12B forming the aperture 18. The projection 59 is formed to have a length of at least the height of the aperture 18 and span the whole height direction of the door 50 at the outer face of the rear end portion of the door 50. Thus, the projection 19 and the projection 59 overlap and contact or are proximate to one another in the plate thickness direction of the door 50 in plan view. Therefore, a closed structure (“labyrinth construction”) is formed by these projections 19 and 59, and hence ingression of dust and the like is suppressed and further prevented.

Similarly, the projection 57 of the door 50 contacts or is proximate to the projection 17 to engage with the projection 17 from the case rightward side. The projection 17 is formed with a length of at least the height of the aperture 18 at the inner face of the vicinity of the edge portion of the front side wall 12A forming the aperture 18. The projection 57 is formed to have a length of at least the height of the aperture 18 and to span the whole height direction of the door 50 at the inner face of the front end portion of the door 50. Therefore, a closed structure (“labyrinth construction”) is formed by the projections 17 and 57, and hence ingression of dust and the like is suppressed and further prevented.

When the recording tape T is to be used, the recording tape cartridge 10 is loaded into a drive device in the direction of arrow A with the front side wall 12A leading. Accordingly, firstly, an opening/closing member provided at the drive device engages with the projection 56 of the door 50. Then, in this state, as the recording tape cartridge 10 moves further in the direction of arrow A, the opening/closing member moves the projection 56 relatively rearward against the urging force of the coil spring 58. Correspondingly, the door 50 from which the projection 56 is protruded slides rearward in the groove portions 64 along the right side wall 12B and at the inner side of the right side wall 12B, and opens up the aperture 18.

When the recording tape cartridge 10 is loaded to a predetermined depth in the drive device and the aperture 18 is completely opened up, the recording tape cartridge 10 descends by a predetermined height, and a positioning member of the drive device (not shown) enters a positioning hole portion (not shown) that is formed in the lower case 16. Accordingly, the recording tape cartridge 10 is precisely positioned at a predetermined position in the drive device, and further sliding (rearward movement) of the door 50 is restricted.

In accordance with the operation of descent of the recording tape cartridge 10, the rotary shaft relatively enters through the gear aperture 40, and the driving gear is meshed with the reel gear 44. Correspondingly, in accordance with the operation of the driving gear meshing with the reel gear 44, the leg portions 94 protruding beyond the reel gear 44 are pushed up in opposition to the urging force of the compression coil spring 98, the braking member 80 is pushed upward via the release member 90, and the meshing of the braking gear 84 with the engaging gears 48 is released.

Then, in a state in which the driving gear and the reel gear 44 are fully meshed, the reel plate 46 is attracted and retained by magnetic force of the annular magnet provided at the inner side of the driving gear. Thus, the reel 20 is put into a lock-released state in which the reel 20 is relatively rotatable with respect to the case 12, inside the case 12, while the meshing of the reel gear 44 with the driving gear is maintained.

Meanwhile, the drawing-out member provided at the drive device enters into the case 12 through the aperture 18 that has been opened up, and grips and draws out the leader pin 30 positioned and retained in the pin retention portions 36. At this time, because the recording tape cartridge 10 is precisely positioned in the drive device, the drawing-out member may reliably engage the hooks thereof on the annular grooves 32 of the leader pin 30. Furthermore, because the rotation-locked state of the reel 20 has been released, the reel 20 may turn in accordance with the operation of drawing out of the leader pin 30.

Hence, the leader pin 30 that has been drawn out through the aperture 18 is accommodated at an unillustrated take-up reel. Then, the take-up reel and the reel 20 are driven to rotate in synchrony, and thus the recording tape T is wound around the take-up reel while being sequentially drawn out from the case 12. Recording and/or reproducing of information is carried out by a recording/reproducing head (not shown) which is disposed along a predetermined tape path.

When the recording and/or reproducing has ended and the recording tape cartridge 10 is to be ejected from the drive device, firstly, the recording tape T is wound back to the reel 20 by the rotary shaft turning in the opposite direction. Then, when the recording tape T has been completely wound back onto the reel 20 and the leader pin 30 is retained in the pin retention portions 36, the recording tape cartridge 10 rises by the predetermined height and the positioning member disengages from the positioning hole portion. In addition, the rotary shaft disengages from the gear aperture 40, and the meshing of the driving gear with the reel gear 44 is released.

Correspondingly, the braking member 80 and the release member 90 are pressed downward by the urging force of the compression coil spring 98, and the leg portions 94 enter into the pass-through holes 28A and protrude from the lower face of the base wall 28 to a predetermined height beyond the reel gear 44. In addition, the braking gear 84 meshes with the engaging gears 48. Thus, the reel 20 is again put into the rotation-locked state in which relative rotation thereof within the case 12 is blocked. Thereafter, the recording tape cartridge 10 is moved in the direction opposite to the direction of arrow A by an unillustrated ejection mechanism.

Correspondingly, in accordance with this movement, the door 50 slides in the direction of closing the aperture 18 due to the urging force of the coil spring 58, and the aperture 18 is completely closed (i.e., returning to the original state). At this time, the projection 59 engages with the projection 19 from the case rearward side, and the projection 57 engages with the projection 17 from the case rightward side. Thus, the closed structures (labyrinth constructions) are formed again, and ingression of dust or the like, through gaps that result between the door 50 and the right side wall 12B and front side wall 12A by which the aperture 18 is formed, is again suppressed and further prevented. Hence, relative rotation of the reel 20 with respect to the case 12 is locked, and the reel 20 whose aperture 18 is closed off is completely ejected from inside the drive device.

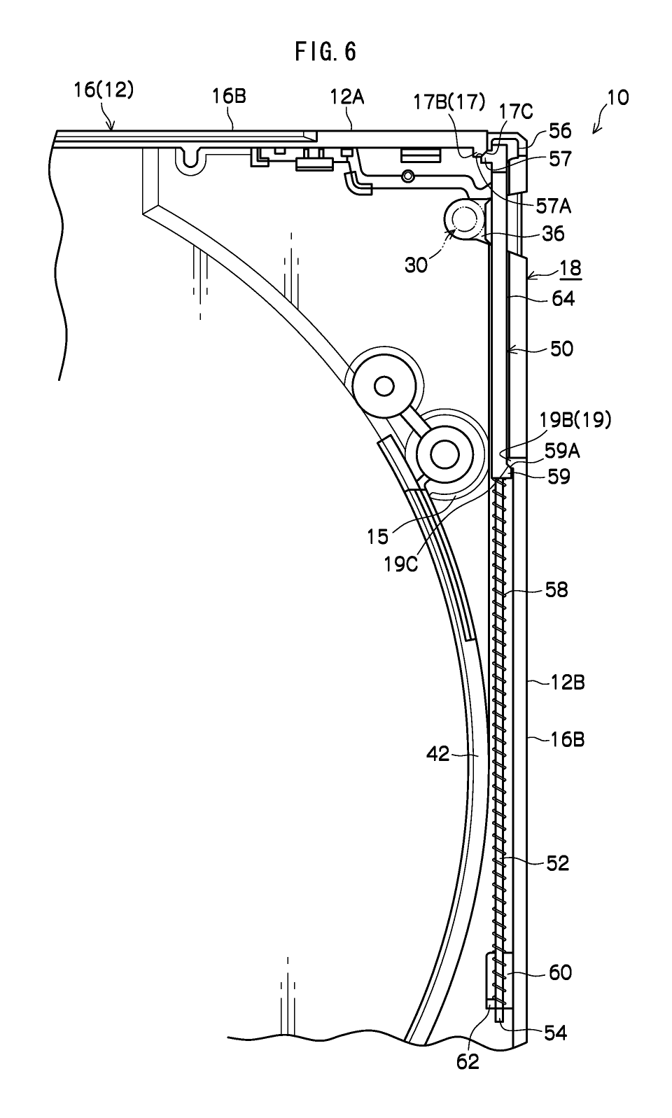

Hereabove, the projection 19 serving as the first dustproofing wall portion relating to the exemplary embodiment and the projection 59 serving as the second dustproofing wall portion have been described on the basis of the first exemplary embodiment. However, the shapes of the projection 19 and the projection 59 may be formed in shapes illustrated by a variant example in FIG. 6. That is, surfaces of the projection 19 and the projection 59 that engage with (oppose) one another may be formed as respective tapering surfaces 19C and 59A.

Even if the projection 19 and the projection 59 are formed thus, the projection 19 and the projection 59 contact or are proximate to overlap with one another in the plate thickness direction of the door 50 in plan view. Therefore, a closed structure (labyrinth construction) may be formed. Similarly, a structure is possible in which surfaces of the projection 17 and the projection 57 that engage with (oppose) one another are formed as tapering surfaces 17C and 57A, respectively, and these may be caused to contact or be proximate.

However, when the surfaces of the projection 19 and the projection 59 that are engaged (opposed) and the surfaces of the projection 17 and the projection 57 that are engaged (opposed) are formed in directions substantially orthogonal to the sliding direction of the door 50 as shown in FIG. 1 to FIG. 5, a more excellent closed structure (labyrinth construction) is provided by the surfaces and therefore they are preferable. That is, the shapes illustrated in FIG. 1 to FIG. 5 may produce an improvement in dustproofing of the recording tape cartridge 10 more excellently and are thus preferable.

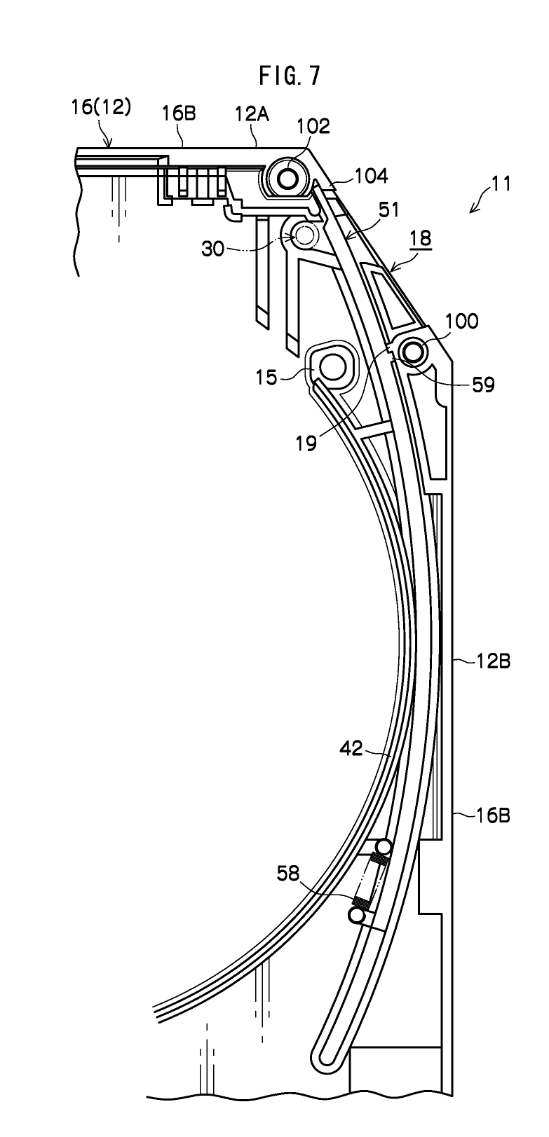

Furthermore, with the recording tape cartridge 10 of the first exemplary embodiment including the variant example illustrated in FIG. 1 to FIG. 6, a structure is formed that is provided with the door 50 that slides in the direction parallel to the direction of loading into the drive device. However, as in a second exemplary embodiment illustrated in FIG. 7, a case of a recording tape cartridge 11 that is provided with a plan-view substantially circular arc-form door 51 (shielding member), which slides along a predetermined circumference, is similarly applicable. Accordingly, the second exemplary embodiment will be described next. Portions that are the same as in the above-described first exemplary embodiment will be assigned the same reference numerals and detailed descriptions thereof will not be given.

In the case of the recording tape cartridge 11, the projection 19 (the first dustproofing wall portion) that protrudes by a predetermined height to the case inward direction is integrally formed to protrude from the edge portion of the right side wall 12B forming the aperture 18. A screw boss 100 is provided near the edge portion the right side wall 12B. The projection 59 (the second dustproofing wall portion), which engages with the projection 19 when the aperture 18 is closed off by the plan-view substantially circular arc-form door 51, is integrally formed to protrude from the outer face of an intermediate portion of door 51 that opposes the screw boss 100, spanning the whole of the height direction of the door 51. The projection 59 has a length of at least the height of the aperture 18 and a predetermined length to the case outward direction.

That is, when the aperture 18 is closed off by the door 51, the projection 59 formed at the outer face of the door 51 engages, from the case rearward side, with the projection 19 formed at the inner face of the screw boss 100 over the whole of the height direction of the door 51 (i.e., the projection 59 and the projection 19 contact or are proximate to overlap with one another in the plate thickness direction of the door 51 in plan view. Therefore, when the aperture 18 is closed off by the door 51, a closed structure (a labyrinth construction) is formed by the projections 19 and 59, between an edge portion that forms the aperture 18 and the intermediate portion of the door 51. Hence, ingression of dust or the like is suppressed and further prevented.

Here, as illustrated in FIG. 7, a front end portion of the door 51 is constituted to enter the inner side of an angled wall portion 104, which is provided at an outer side of an edge portion of the front side wall 12A that forms the aperture 18. A screw boss 102 is provided near to the edge portion of the front side wall 12A. Therefore, when the aperture 18 is closed off, the angled wall portion 104 and the front end portion of the door 51 overlap with one another. That is, the outer face of the front end portion of the door 51 contacts or is proximate to the inner face of the angled wall portion 104, and a closed structure (labyrinth construction) is formed. Therefore, when the aperture 18 is closed off, ingression of dust or the like through a gap formed between the angled wall portion 104 and the door 51 is suppressed and further prevented.

Hereabove, the recording tape cartridges 10 and 11 relating to a present exemplary embodiment has been described. However, the recording tape cartridge 10 relating to the present exemplary embodiment is not limited to the illustrated examples, and may be suitably modified in design within a scope not departing from the present invention. For example, in the exemplary embodiments described above, the doors 50 and 51 are structures that slide at the inner side of the right side wall 12B to open and close the aperture 18. However, structures that slide at the outer side of the right side wall 12B to open and close the aperture 18 may be employed.

That is, in such a case, the projection 19 that serves as the first dustproofing wall portion is integrally provided protruding from the outer face of the edge portion of the right side wall 12B, with a length of at least the height of the aperture 18, and the projection 59 that serves as the second dustproofing wall portion is integrally provided protruding from the inner face of the rear end portion of the door 50 or the inner face of the intermediate portion of the plan-view substantially circular arc-form door 51, spanning the whole of the height direction of the respective door 50 or 51 and having a length of at least the height of the aperture 18. In either case, when the projection 19 is formed to protrude from the edge portion of the right side wall 12B that forms the aperture 18, ingression of dust or the like through a gap resulted between the right side wall 12B and the door 50 or 51 is suppressed and further prevented at the vicinity of an entrance to such a gap, which is preferable.

Moreover, it is sufficient for the recording tape T wound on the reel hub 22 to be understood as being an information recording/reproducing medium in a long tape form at which recording of information and reproducing of recorded information are possible; and the recording tape cartridge 10 that rotatably accommodates the single reel 20 is obviously applicable to a recording tape T of any recording/reproducing format.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording tape cartridge comprising:
a case that rotatably accommodates a single reel on which recording tape is wound;
a shielding member that slides along a side wall of the case, and opens and closes an aperture which is formed in the side wall for drawing out of a leader member attached to an end portion of the recording tape;
a first dustproofing wall portion that is provided protruding from a portion of the side wall; and
a second dustproofing wall portion that is provided protruding from the shielding member,
wherein, when the aperture is closed, the first dustproofing wall portion opposes the shielding member and the second dustproofing wall portion contacts or is proximate to the first dustproofing wall portion.

2. The recording tape cartridge according to claim 1, wherein the first dustproofing wall portion and the second dustproofing wall portion have lengths of at least a height of the aperture.

3. The recording tape cartridge according to claim 1, wherein the first dustproofing wall portion and the second dustproofing wall portion contact or are proximate so as to overlap with one another in a direction of thickness of the shielding member.

4. The recording tape cartridge according to claim 3, wherein surfaces of the first dustproofing wall portion and the second dustproofing wall portion that contact or are proximate one another are formed so as to be provided in a direction substantially orthogonal to a direction of sliding of the shielding member.

5. The recording tape cartridge according to claim 1, wherein the first dustproofing wall portion is provided protruding from an edge portion, of the side wall, that forms the aperture.
